(19) United States
(12) Patent Application Publication
(10) Pub. No.: US 2016/0313178 A1
(43) Pub. Date: Oct. 27, 2016

(54) SEMICONDUCTOR DEVICE

(71) Applicant: DENSO CORPORATION, Kariya-city (JP)

(72) Inventor: Mutsuya MOTOJIMA, Kariya-city (JP)

(21) Appl. No.: 15/099,978

(22) Filed: Apr. 15, 2016

(30) Foreign Application Priority Data
Apr. 24, 2015 (JP) 2015-89294

(51) Int. Cl. G01J 1/42; B60S 1/08; G01J 1/02

(52) U.S. Cl. CPC G01J 1/4228; G01J 1/0204; B60S 1/0844; G01J 2001/446

(57) ABSTRACT

A semiconductor device includes light receiving elements, selection switches, a light receiving circuit and a control circuit. Each light receiving element receives a light and outputs a detection signal according to an intensity of the light. The selection switches are correspondingly provided for the light receiving elements. Each selection switch selectively allows the detection signal to be outputted. The light receiving circuit includes a capacitive coupling element and an amplifying circuit. The light receiving circuit is provided for a prescribed number of the light receiving elements and connected to the light receiving elements through the selection switches. The control circuit switches the selection switches sequentially so that the detection signals of the light receiving elements are received in the light receiving circuit through the capacitive coupling element. The control circuit controls the light receiving circuit to process the detection signals by amplifying the detection signals by the amplifying circuit.

### CROSS REFERENCE TO RELATED APPLICATION

This application is based on Japanese Patent Application No. 2015-89294 filed on Apr. 24, 2015, the disclosure of which is incorporated herein by reference.

### TECHNICAL FIELD

The present disclosure relates to a semiconductor device.

### BACKGROUND

For example, as a semiconductor device used in a device equipped in a vehicle and detecting a raindrop, a semiconductor device including a light receiving element that receives light emitted from a light emitting element has been known. A raindrop detection device is mounted on an inner surface of a windshield the vehicle. The raindrop detection device emits light toward the windshield from a light emitting element and receives reflected light by a light receiving element. When a raindrop adheres to the windshield, a reflectance is changed and a ratio of the light of the light emitting element transmitting is increased. As a result, the light received by the light receiving element is decreased and an intensity of the received light is decreased. The raindrop detection device detects the raindrop based on this decreased intensity of the received light.

In this case, as an example of the semiconductor device providing a light receiving section of the raindrop detection device, a semiconductor device including a photodiode as the light receiving element can be considered. When the light emitted from the light emitting element is reflected and received by the photodiode, the amount of light received by the photodiode is changed. The change of the amount of the light according to a state of adhesion of the raindrop can be detected based on a change of a photocurrent of the photodiode.

In order to detect the raindrop based on the change of the photocurrent of the photodiode, for example, a semiconductor device according to JP 2013-24618 A includes a high-pass filter, a current-voltage converting circuit, a voltage high-pass filter, a peak-hold circuit and a non-inverting amplifying circuit in addition to the photodiode. Hence, an additional circuit providing a light receiving element is large and an area occupied by the element increased. Therefore, in the case where a broad light receiving region is set by arranging the light receiving elements bidimensionally in order to detect the raindrop accurately, it will be difficult to arrange such a light receiving element densely and to increase an integration degree.

### SUMMARY

It is an object of the present disclosure to provide a semiconductor device having light receiving elements arranged densely and being capable of increasing detection accuracy.

According to an aspect of the present disclosure, a semiconductor device includes light receiving elements, selection switches, a light receiving circuit and a control circuit. The light receiving elements are arranged in a light receiving section. Each of the light receiving elements receives an incident light and outputs a detection signal of a current according to an intensity of the incident light. The selection switches are correspondingly provided for the light receiving elements. Each of the selection switches selectively allows the detection signal to be outputted. The light receiving circuit includes a capacitive coupling element and an amplifying circuit. The light receiving circuit is provided for a prescribed number of the light receiving elements. The light receiving circuit is connected to the light receiving elements through the selection switches. The control circuit switches the selection switches sequentially so that the detection signals of the light receiving elements are received in the light receiving circuit through the capacitive coupling element. The control circuit controlling the light receiving circuit to process the detection signals b amplifying the detection signals by the amplifying circuit.

According to the structure described above, the detection signals of the light receiving elements that are selected by the selection switches can be received in the light receiving circuit through the capacitive coupling element, and the light receiving circuit can amplify and output the detection signals. Since the control circuit switches the light receiving elements by switching the selection switches, plural detection signals of the light receiving elements can be inputted in the light receiving circuit sequentially.

Accordingly, it is not necessary to provide the light receiving circuits correspondingly for the light receiving elements. Therefore, a structure of a pixel, which includes the light receiving element and the selection switch, can be compact and the light receiving elements can be arranged densely in the light receiving section. That is, an integration degree of the light receiving elements can be increased. Furthermore, in the light receiving circuit, the detection signals that are outputted from the light receiving elements can be outputted to the amplifying circuit through the capacitive coupling element. As a result, effects of an ambient light can be decreased and an accurate detection operation can be performed.

### BRIEF DESCRIPTION OF THE DRAWINGS

The above and other objects, features and advantages of the present disclosure will become more apparent from the following detailed description made with reference to the accompanying drawings, in which like parts are designated by like reference numbers and in which:

FIG. 1 is an electrical block diagram of a raindrop detection device according to a first embodiment;

FIG. 2 is an electrical block diagram of the raindrop detection device according to the first embodiment;

FIG. 3 is a cross-sectional view illustrating a whole structure of the raindrop detection device;

FIG. 4 is a time chart of a signal processing performed in a light receiving circuit;

FIG. 5 is a flowchart of a preliminary detection processing according to a second embodiment;

FIG. 6 is a diagram illustrating an operation of a light receiving element according to the second embodiment;

FIG. 7 is a flowchart of a preliminary detection processing according to a third embodiment; and

FIG. 8 is a diagram illustrating an operation of a light receiving element according to the third embodiment.

### DETAILED DESCRIPTION

### First Embodiment

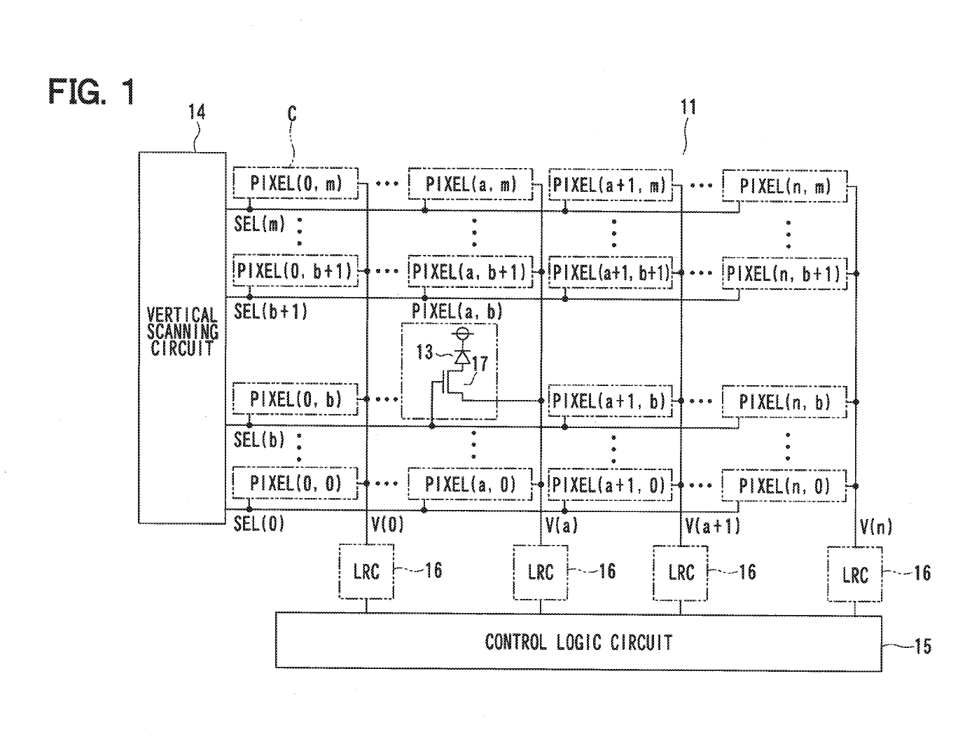

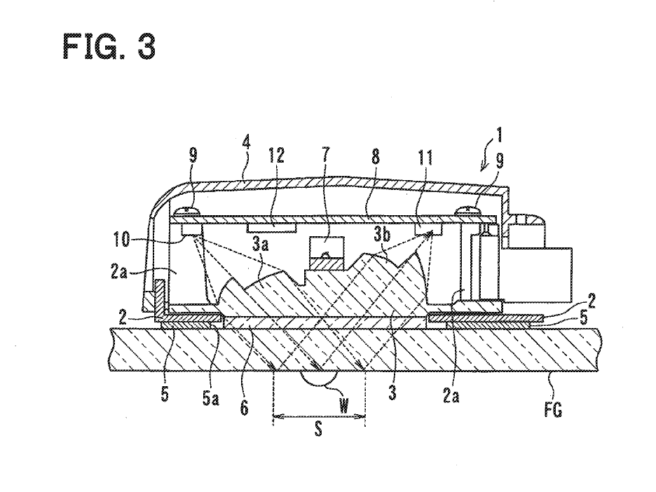

Hereinafter, a first embodiment in which the present disclosure is employed to a reflection type raindrop sensor will be described with reference to FIG. 1 to FIG. 4. FIG. 3 is a cross-sectional view illustrating a whole structure of a raindrop sensor 1. In FIG. 3, a body case 2 is made of a transparent member and is formed integrally with a lens 3, which is a light transmitting body. The body case 2 has a housing 4 thereon so that the whole raindrop sensor 1 is covered.

The body case 2 is attached to a bracket 5 having an opening 5a, and is mounted on an inner surface of a windshield FG of a vehicle. The windshield FG has the inner surface that is inside of the vehicle, and an outer surface that is out of the vehicle. The lens 3 of the body case 2 is arranged opposing to the windshield FG and is stuck on the windshield FG through a silicon sheet 6 having a light transmitting property. The lens 3 is pressed to the silicon sheet 6 by a metal fitting 7 that is bridged from one side wall to another side wall of the body case 2 so as to enhance the sticking of the lens 3 to the windshield FG.

The body case 2 has four columns 2a at four corners. The columns 2a have a predetermined height and are formed integrally with the body case 2. The columns 2a have a printed substrate 8 thereon. The printed substrate 8 is fixed by screws 9 or the like. The printed substrate 8 has an LED 10 and a light receiving section 11 attached to a surface adjacent to the lens 3. The LED 10 emits light toward the windshield FG. The light receiving section 11 is a semiconductor device that receives light reflected on the windshield FG and passing through the lens 3. The printed substrate 8 also has an IC 12 including a CPU preforming a signal processing of detected information.

The lens 3 is made of a transparent resin molded and includes convex lens portions that are obtained by dividing a convex lens. The light emitted from the LED 10 is refracted through a convex lens portion 3a to enter the lens 3 as a parallel light. The light is projected on the inner surface of the windshield FG through the lens 3 and the silicon sheet 6. The light entering inside of the windshield FG from the inner surface of the windshield FG is projected on a prescribed region of the outer surface of the windshield FG. The prescribed region is a detection region S for detecting a state of an adhesion of the raindrop.

The light of the LED 10 reaching the outer surface of the windshield FG is mostly reflected and enters again the lens 3 through the silicon sheet 6. The light is condensed by the convex lens portion 3b of the lens 3 into a prescribed size and is received by the light receiving section 11. In a light receiving surface of the light receiving section 11, pixels C are arranged in a matrix form, as described later. The light is received by photodiodes 13 provided for the pixels C. As such, a state of light receiving differing depending on a position of the detection region S can be detected.

In the above structure, when a raindrop W adheres to the windshield FG, since a main component of the raindrop W is water that has a similar refraction factor to the windshield FG, some components of the light of the LED 10 are not reflected on the portion of the windshield FG to which the raindrop W adheres. Some components of the light of the LED 10 pass through the windshield FG toward the raindrop W. As a result, components of the reflected light received by the lens 3 are decreased, and a portion where the intensity of the reflected light is weakened can be detected as the portion to which the raindrop W adheres. In other word, by calculating an area of the detection region S in which the reflected light is decreased, an area to which the raindrop W adheres, that is, the amount of the raindrop W can be determined.

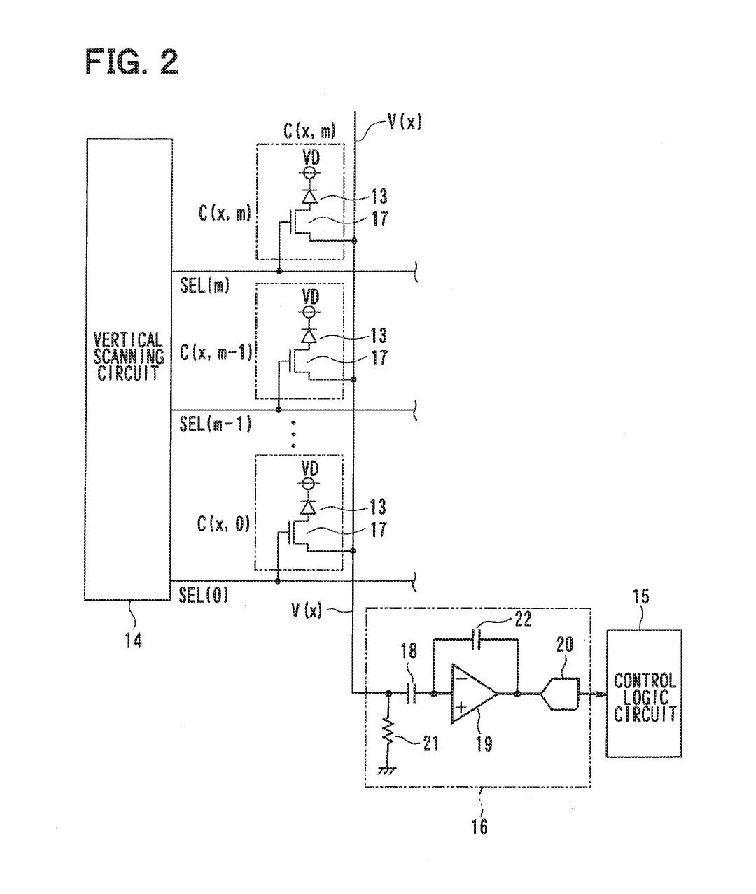

Next, an electrical structure of the raindrop sensor 1 will be described with reference to FIG. 1 and FIG. 2. FIG. 1 illustrates a schematic structure of the light receiving section 11 and light receiving circuits (LRC) 16. In the light receiving section 11, the photodiodes 13, which are the light receiving elements, are arranged in the matrix form. For example, the matrix form includes m lines and n columns. The photodiodes 13 function as pixels C of a light receiving surface. Hereinafter, a photodiode 13 at an intersection of a line x and a column y will be referred to as a photodiode 13 (x, y), based on the xy coordinate. For example, a photodiode 13 (0, 0) is arranged corresponding to a pixel C (0,0) on a line 0 and a column 0. A photodiode 13 (a, b) is arranged corresponding to a pixel C (a, b) on line a and column b.

At a left side of the photodiodes 13 a vertical scanning circuit 14 is provided. At a bottom side of the photodiodes 13, a control logic circuit 15, which is a control circuit, is provided. The pixels C (0, y) to C (n, y) (y: 0 to m) on the line y are commonly connected to a selection line SEL (y) that is extended from the vertical scanning circuit 14. The pixels C (x, 0) to C (x, m) (x: 0 to n) on the column x are commonly connected to an output line V (x) that is for extracting detection signals of the photodiodes 13. The output lines V (x) are connected to the control logic circuit 15 through the light receiving circuits 16.

Next, a structure of the pixel C (x, y) and a structure of the light receiving circuit 16 (x) will be described with reference to FIG. 2. FIG. 2 illustrates an electrical structure corresponding to one light receiving circuit 16 as a unit. Each photodiode 13 providing the pixel C (x, y) has one FET 17. The photodiode 13 has a cathode connected to a power terminal VD, and an anode connected to the output line V(x) through the FET 17, which is a selection switch. A gate of the FET 17 is connected to the selection line SEL (y).

Since each pixel C (x, y) has the photodiode 13 and the FET 17 connected to the photodiode 13, a space of each pixel C (x, y) can be almost equal to a space occupied by the photodiode 13. Therefore, adjacent pixels C (x, y) can be arranged close to each other, that is, can be arranged densely.

When the vertical scanning circuit 14 outputs a selection signal φ (y) to the selection line SEL (y), the FET17 connected to the selection line SEL (y) is turned on and the photodiode 13 outputs a light receiving signal to the output line V(x). The light receiving circuit 16 receives the light receiving signal and processes the light receiving signal. The light receiving circuit 16 includes a capacitor 18, which is a capacitive coupling element, an amplifying circuit 19 and an AD converting circuit 20. The output line V (x) is connected to an inverse input terminal of the amplifying circuit 19 through the capacitor 18, and connected to ground through a resistor 21. A non-inverse input terminal of the amplifying circuit 19 is applied with a reference voltage. A capacitor 22 is connected between the input terminal and the output terminal of the amplifying circuit 19. The output terminal of the amplifying circuit 19 is connected to the

AD converting circuit 20. The AD converting circuit 20 converts an analog signal outputted from the amplifying circuit 19 to a digital signal and outputs the digital signal to the control logic circuit 15.

The vertical scanning circuit 14 outputs the selection signal φ (y) to the specific selection line SEL (y) to turn on the FET 17 based on the signal outputted from the control logic circuit 15. The light receiving signals outputted from the photodiodes 13 that are selected by the selection signal φ (y) are outputted to the output line V (x) through the FETs 17. The vertical scanning circuit 14 outputs the selection signals φ (y) to the selection lines SEL (y) and switches the selection lines SEL (y) sequentially. As such, the light receiving signals of the photodiodes 13 of the pixels C (x, y) of all lines or specific lines can be outputted to the output line V (x).

In the light receiving circuit 16, since the light receiving signals of the photodiodes 13 that are outputted sequentially are AC-coupled by the capacitor 18, change components of detection currents, which are the light receiving signals, are outputted to the amplifying circuit 19. When an intensity of the light received by the photodiode 13 is high, the change component of the detection current increases. Therefore, the signal corresponding to the intensity of the received light can be detected.

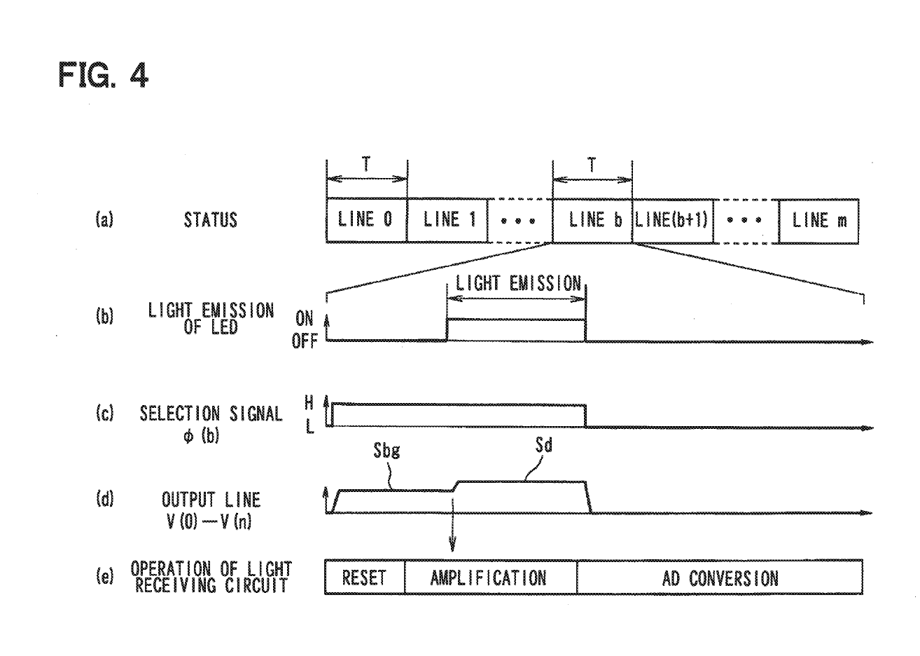

Effects of the above structure will be described with reference to FIG. 4. A detection operation of the raindrop sensor 1 is started based on a control signal outputted from the IC 12. The control logic circuit 15 assigns the detection operation to the lines (from line 0 to line m) at every prescribed periods, and outputs an order to allow the vertical scanning circuit 14 to output the selection signal)(y) sequentially (see, (c) of FIG. 4).

The detection operation in each line will be described. For example, the detection operation in the line b will he described. In a former half of a period T (see, (a) of FIG. 4), the vertical scanning circuit 14 outputs the selection signal φ(b) to turn on the FETs 17 of the corresponding pixels C (0, b) to C (n, b) on the line b. The light receiving signals of the photodiodes 13 can be outputted to the output lines V (0) to V (n).

In a former half of the period in which the selection signal φ(b) is outputted, the control logic circuit 15 resets the operation of the light receiving circuit 16 so that the light receiving circuit 16 can perform the amplifying operation. In a latter half of the period in which the selection signal c(b) is outputted, the control logic circuit 15 outputs a driving signal to allow the LED 10 to emit a light. As a result, the LED 10 emits a light for detecting toward the lens 3 (see (b) of FIG. 4).

The light emitted by the LED 10 passes through the lens 3 and enters inside of the windshield FG. The light reflected on the outer surface of the windshield FG advances toward the photodiode 13 and the photodiode 13 receives the light. When water such as the raindrop W adheres to the surface of the windshield FG, a part of the light of the LED 10 enters the raindrop W, due to a refraction factor. As a result, the amount of the light reflected toward the photodiode 13 is decreased.

When the FET 17 is turned on by the selection signal φ(b), the photodiodes 13 of the pixels C (0, b) to C (n, b) are biased by the power source VD to output the photocurrents corresponding to the intensity of the light received by the photodiodes 13 ((d) of FIG. 4). In the former half of the period in which the selection signal φ(b) is outputted, the LED 10 is not been lighted, and the photodiode 13 outputs a photocurrent Sbg having a level corresponding to the intensity of the incident light of outside passing through the windshield FG.

Since the photocurrent Sbg is a light component that does not affect the detection operation of the raindrop, the photocurrent Sbg flows as a component of an ambient light, that is, a background light. For example, when the ambient light is strong because of a solar radiation in daytime, a value of the photocurrent is large. When the ambient light is weak because of a situation in nighttime, in rainy weather or in a tunnel, the value of the photocurrent is small.

When the photodiode 13 receives the light emitted from the LED 10, the photodiode 13 outputs the light receiving signal Sd corresponding to the light of the LED 10 to the output lines V (0) to V (n). At this moment, a level of the output signal is largely changed. The amount of the change (Sd−Sbg=ΔS) is a difference between the signal level before the LED 10 is lighted and the signal level after the LED 10 is lighted. A value proportional to the amount ΔS is a differential input value that is inputted to the amplifying circuit 19 through the capacitor 18.

Regarding the photocurrent Sd when the LED 10 is lighted, a value when the raindrop W does not adhere to the windshield FG is defined as a Sd0. A value when the raindrop W adheres to the windshield FG is defined as a Sdw. The Sdw is smaller than the Sd0 because the amount of the light decreases due to the raindrop W adhering to the windshield FG. Since this result affects the amount of the change ΔS, it can be determined whether the raindrop W adheres to the windshield FG. As the number of the pixels C (x, y) that have determined the adhesion of the raindrop W to the windshield FG increases in the light receiving surface, it can be determined that the amount of rain is large.

In the light receiving circuit 16, the amplifying circuit 19 amplifies a signal corresponding to the amount of the change of the light receiving current received in the light receiving circuit 16 through the capacitor 18. The signal is converted into a digital signal in the AD converting circuit 20 and is outputted to the IC 12. The IC 12 receives the digital signals of all lines each corresponding to the columns and determines the state of the adhesion of the raindrop W to the windshield FG.

Since the amount of the change ΔS of the photocurrent outputted to the amplifying circuit 19 changes depending on the level of the background light, as described above, a suitable amplifying operation can be performed by setting an amplification factor within a range concerning the amount of the change ΔS of the photocurrent.

According to the present embodiment, each pixel C (x, y) includes the photodiode 13 and the FET 17. The light receiving circuit 16 detects the light signals that are outputted from the pixels in which the FETs 17 receive the selection signals and are capacitive coupled by the capacitor 18. Therefore, the area occupied by each pixel C can be decreased and the pixels C can be arranged densely in the light receiving surface. As a result, the amount of the light entering the photodiode 13 can be sufficiently secured. Also, effects of the ambient light can be decreased by the capacitive coupling and hence the detection accuracy can be increased.

### Second Embodiment

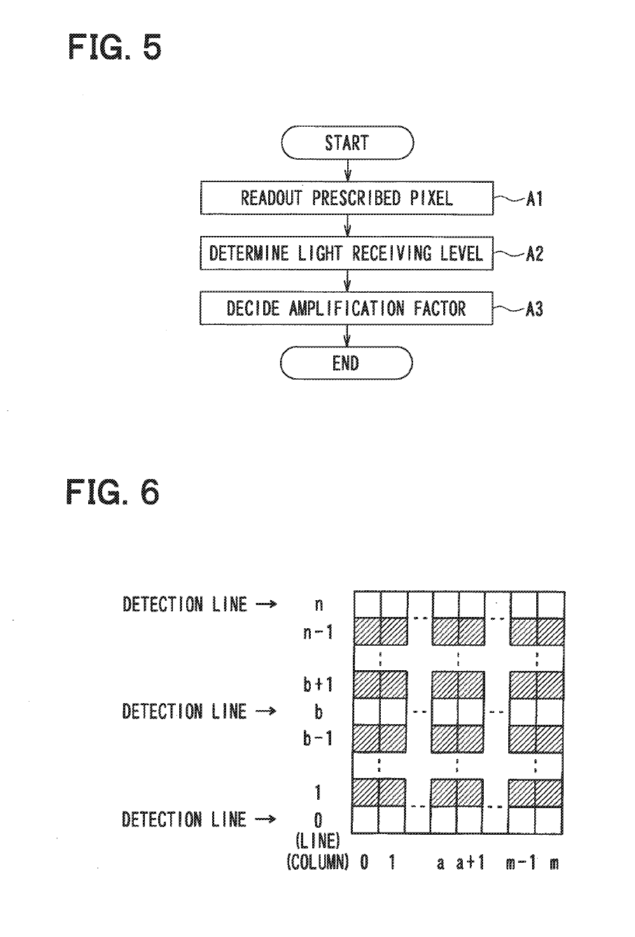

FIG. 5 and FIG. 6 are diagrams illustrating a second embodiment of the present disclosure. Hereinafter, points different from the first embodiment will be described. In the second embodiment, the detection operation of the raindrop as described in the first embodiment is performed and a preliminary detection operation is also performed before the detection operation of raindrop.

As described in the first embodiment, the level of the ambient light entering differs depending on a circumstance of the detecting of the raindrop W. The preliminary detection operation is performed to restrict the detection accuracy from being decreased due to the difference of the circumstance.

For example, the preliminary detection operation is performed to achieve an accurate detection operation in a situation in which the intensity of the light of solar radiation differs depending on the weather. Also, the preliminary detection operation is performed to achieve an accurate detection operation in the situation in which the amount of the light of solar radiation largely decreases because the raindrop sensor 1 is in the tunnel or in shade of a building.

As described above, the level of the light entering through the windshield FG as the background light before the LED 10 is lightened largely differs depending on the situation such as a bright circumstance or a dark circumstance. Therefore, when the LED 10 is lightened, there is a difference between the intensity of the light reflected on the detection region S and the intensity of the background light. As a result, the amount of the change of the detection signal largely differs, for example, when the circumstance is suddenly darkened or brightened. In the second embodiment, the change of the background light as described above is recognized by the preliminary detection processing. As a result, an accurate detection operation can be achieved by setting the amplification factor suitably in the amplifying circuit 19 of the light receiving circuit 16 according to the level of the light receiving signal.

In the second embodiment, the processing shown in FIG. 5 is performed as the preliminary detection processing. First, at A1 the control logic circuit 15 readouts the prescribed pixels. For example, as shown in FIG. 6, to determine the intensity of the background light, the control logic circuit 15 readouts the pixels C(x, 0), C(x, n), C(x, b) (x=0 to m) on the three lines of the whole lines, that is, a line 0 and a line n of both end portions, and a line b of the middle portion.

At A2, the IC 12 determines the light receiving level of pixels C that are readout by the control logic circuit 15. The CPU of the IC 12 determines the light receiving level based on the digital signals obtained through the AD converting circuits 20 of the light receiving circuits 16. At A3, based on the determination result, suitable amplification factors of the amplifying circuits 19 of the light receiving circuits 16 are decided and, thereafter, the decided amplification factors are set through the control logic circuit 15.

As described above, the detection processing can be performed under a condition where the state of the background light right before the detection processing is performed is detected by the preliminary detection processing, and the amplification factors of the amplifying circuits 19 of the light receiving circuits 16 are suitably set.

According to the second embodiment described above, in the detection operation of the first embodiment, the change of the background light can be considered and, therefore, the detection accuracy can be further improved.

Although in the second embodiment, three lines of pixels C are used in the preliminary detection operation, the present disclosure is not limited to the second embodiment. Similar effect can be achieved even when the light receiving level of the pixels C, the number of which is less than the number of the pixels that are used in the normal detection operation, are used. For example, the pixels C may be readout in every plural lines. The light receiving level of the prescribed pixels of one line may be detected. Furthermore, it is also possible that a prescribed pixel C is set as a pixel for being monitored, and the amplification factor is set based on the light receiving level of the prescribed pixel C.

The preliminary detection processing may be performed under the condition where the pixels C are selected in plural patterns and different detection accuracies can be set by selecting the patterns depending on the situation.

### Third Embodiment

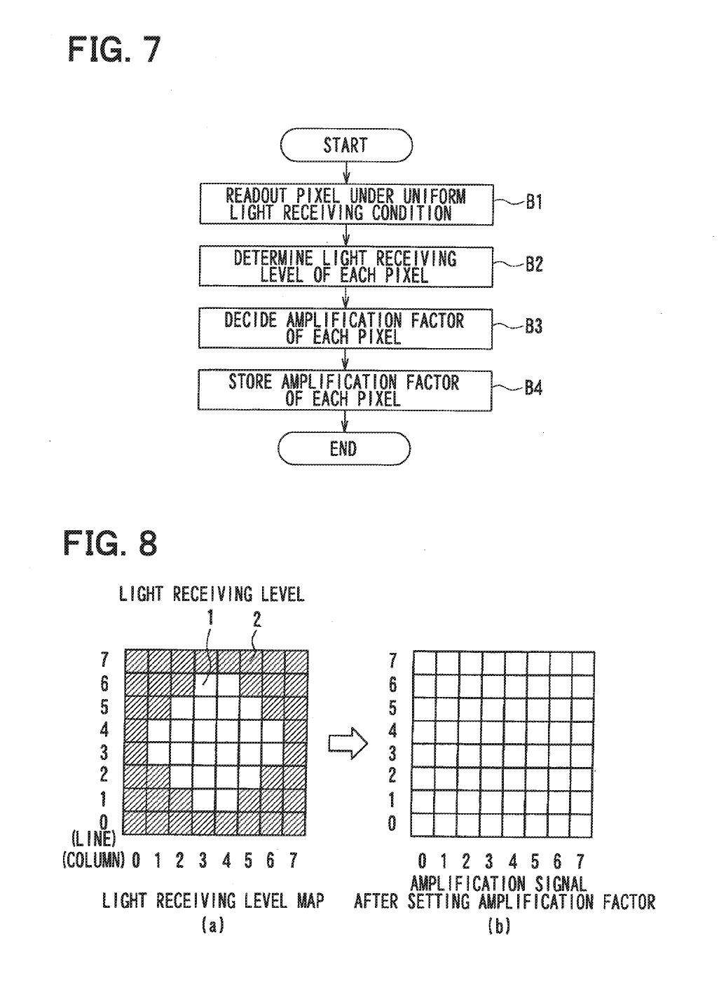

FIG. 7 and FIG. 8 are diagrams illustrating a third embodiment of the present disclosure. Hereinafter, points different from the first embodiment will be described.

In the third embodiment, a preliminary detection operation is performed, in which different amplifying operations are performed depending on positions of the pixels C in order to uniformize the light receiving levels. The light receiving levels of the pixels C differ depending on a shape or a state of the lens 3 even when the condition of the light emitted from the LED 10 is same.

For example, the intensity of the light passing through the lens 3 differs depending on the position of the lens 3 due to a shape, a material or a soil of the lens 3. There is also a possibility that the intensity of the light passing through the lens 3 differs depending on the state of the silicon sheet 6 other than the lens 3, or differs when the lens 3 is exchanged. A distribution of the above-described difference of the light receiving level is recognized by the preliminary detection processing. The amplification factors of the amplifying circuits 19 of the light receiving circuits 16 are set depending on the pixels C so as to uniformize the conditions of the light receiving of the pixels C.

In the third embodiment, the processing shown in FIG. 7 is performed as the preliminary detection processing. At B1, the control logic circuit 15 readouts the pixels C under the condition where the light reflected on the windshield FG is uniformed. Next, at B2, the IC 12 determines the light receiving levels of the pixels C readout by the control logic circuit 15. As such, a map showing the light receiving levels of pixels C can be made (see (a) of FIG. 8). At B3, the IC 12 individually decides the amplification factors of the amplifying circuits 19 based on the determination results so as to equalize the light receiving levels, and, at B4, the IC 12 stores the decided amplification factors of the amplifying circuits 19.

In an actual detection processing, when the light signal is inputted by the photodiode 13 in the light receiving circuit 16, the amplification factors decided for the pixels C are applied to the amplifying circuits 19 and the amplifying operations are performed. As a result, the light receiving condition that differs depending on the state of the lens 3 can be corrected and the light receiving operation can be performed under the uniform condition.

For example, as shown in (a) of FIG. 8, the light receiving section 11 has the pixels C arranged in a matrix form including eight lines and eight columns. In (a) of FIG. 8, when the light receiving level is determined, white pixels C of a center region indicate level 1 in which the light receiving level is high, and hatched pixels C outside of the center region indicate level 2 in which the light receiving revel is low. This distribution is because of the shape of the lens 3, in which much light can pass through in the center region and less light can pass through in the peripheral region.

In such a case, further amplification factors are set for the detection signals inputted to the amplifying circuits 19 through the capacitors 18 from the photodiodes 13 of the pixels C having light receiving level 1 and 2. As a results, as shown in (b) of FIG. 8, the level of the amplification signals outputted from the amplifying circuits 19 do not depend on the positions of the pixels C of the light receiving section 11, and the uniform amplification signals can be obtained.

According to the third embodiment described above, the amplification factors of the amplifying circuits 19 of the light receiving circuits 16 are set depending on the positions of the pixels C. Even when the amount of light, which enters the lens 3 under the same condition, changes due to the state of the lens 3, the uniform amplification signals can be obtained. As a result, accurate light receiving signals can be obtained in every pixels C of the light receiving section 11.

In the third embodiment, the present disclosure is employed to the raindrop sensor. When the present disclosure is employed to the other sensor and when the lens or the filter is exchanged, the preliminary detection processing can be similarly performed.

### Other Embodiments

The present disclosure is not limited to the embodiments described above and may be implemented in various other ways without departing from the gist. For example, the following modifications or the expansion can be made.

Although the light receiving circuits 16 are correspondingly provided for the columns in the above embodiments, the light receiving circuits 16 can be provided for plural pixels C.

Although the windshield FG of the vehicle is used as the light transmitting substance, a resin or other material having a light transmitting property can be used.

The present disclosure can be employed to a sensor other than the raindrop sensor of the vehicle, such as a sensor of a camera.

What is claimed is:

1. A semiconductor device comprising:
a plurality of light receiving elements being arranged in a light receiving section, each of the light receiving elements receiving an incident light and outputting a detection signal of a current according to an intensity of the incident light;
a plurality of selection switches being correspondingly provided for the light receiving elements, each of the selection switches selectively allowing the detection signal to be outputted;
a light receiving circuit including a capacitive coupling element and an amplifying circuit, the light receiving circuit being provided for a prescribed number of the light receiving elements, and the light receiving circuit being connected to the light receiving elements through the selection switches; and
a control circuit switching the selection switches sequentially so that the detection signals of the light receiving elements are received in the light receiving circuit through the capacitive coupling element, the control circuit controlling the light receiving circuit to process the detection signals by amplifying the detection signals by the amplifying circuit.

2. The semiconductor device according to claim 1, wherein
the light receiving circuit is one of a plurality of light receiving circuits,
the light receiving elements are arranged in a matrix form in the light receiving section, the matrix form including lines and columns each having a prescribed number of the light receiving elements, and
each of the light receiving circuits is provided for a prescribed number of lines or columns.

3. The semiconductor device according to claim 1, wherein
the control circuit performs a preliminary detection processing to control the light receiving circuit to receive the detection signals of a prescribed number of the light receiving elements, and to set an amplification factor of the amplifying circuit of the light receiving circuit based on a level of the detection signals.

4. The semiconductor device according to claim 1, wherein
the light receiving circuit is one of a plurality of light receiving circuits,
each of the light receiving elements receives the incident light through a light transmitting body, and
the control circuit sets an amplification factor of the amplifying circuit of each of the light receiving circuits respectively based on a distribution of the intensity of the incident light passing through the light transmitting body.

5. The semiconductor device according to claim 1, wherein
each of the light receiving elements receives a light projected on a light transmitting substance and reflected on the light transmitting substance as the incident light, and
the control circuit detects a state of an adhesion of water on the light transmitting substance based on a signal outputted from the light receiving circuit.
